(19) United States
(12) Patent Application Publication
(10) Pub. No.: US 2004/0133880 A1
(43) Pub. Date: Jul. 8, 2004

(54) Tracking unit tests of computer software applications

(75) Inventors: Luiz Marcelo Aucelio Paternostro, Markham (CA); Marius Slavescu, Richmond Hill (CA)

Correspondence Address: Gregory M. Doudnikoff, IBM Corporation T81/503, PO Box 12195, Research Triangle Park, NC, 27709, US

(73) Assignee: International Business Machines Corporation, Armonk, NY

(21) Appl. No.: 10/671,915

(22) Filed: Sep. 24, 2003

(30) Foreign Application Priority Data
Dec. 6, 2002 (CA) 2,413,695

(51) Int. Cl. G06F 9/44

(52) U.S. Cl. 717/124

(57) ABSTRACT

The present invention provides a testing tool for testing software applications. The tool implements a method for tracking unit tests of a software application, comprising conducting the unit tests on the software application, the unit tests ordered under hierarchical groupings; and tracking the unit tests so as to capture a result of each unit test and a hierarchical position of each unit test within the groupings. The method may further comprise outputting the hierarchical position of each unit test in association with the test result. If at least one of the unit tests is iteratively conducted multiple times, the method may further comprise, each time one of the unit tests is conducted, associating an iteration ordinal indication with a result obtained. The unit tests may be grouped within a test suite, which comprises a highest order grouping of the unit tests, the test suite grouping containing at least one test case, each test case comprising a sub-grouping of the test suite.

### BACKGROUND OF THE INVENTION

1. Field of the Invention

The present invention relates to computer software testing, particularly to software testing tools that track unit tests of software applications.

2. Description of the Related Art

Modern computer software applications (“applications”) are often complex and require extensive testing. Testing of complex applications is typically conducted in different stages. Common stages of software testing include unit testing, component testing, functional testing, system testing and integration testing.

During unit testing, only one unit of an application is tested at a time. A unit may refer to any modular aspect of an application. For example, a unit could refer to a segment of code, a method in a class, or a function of an application. Often, multiple related units are tested together by using test cases and test suites. A test case is a procedure verifying that one or more units of an application perform as intended. For each tested unit, a test result, such as “pass” or “fail,” is produced. A collection of test cases can be executed in an ordered sequence. Such a structured collection is called a test suite. A test suite may also include one or more test suites. The structure of a test suite can be simple or quite complex.

Many unit testing tools, such as JUnit, have been developed in order to allow effective testing of units of a software application. Other testing tools are used for each of component testing, functional testing, system testing, and integration testing. While these various tools can be used to effectively test an application, this approach is not particularly efficient.

There is need for a more efficient manner of testing software applications.

### SUMMARY OF THE INVENTION

The present invention proposes a software application testing tool that tracks the hierarchical information of unit tests being executed and may also track iteration information of unit tests being executed. This additional information allows the unit tests to be used in testing larger sections of an application.

In accordance with the purpose of the invention, as embodied and broadly described herein, an aspect of the invention is a method for tracking unit tests of a software application, comprising conducting the unit tests on the software application, the unit tests ordered under hierarchical groupings; and tracking the unit tests so as to capture a result of each unit test and a hierarchical position of each unit test within the groupings. The method may further comprise outputting the hierarchical position of each unit test in association with the test result. If at least one of the unit tests is iteratively conducted multiple times, the method may further comprise, each time one of the unit tests is conducted, associating an iteration ordinal indication with a result obtained. The unit tests may be grouped within a test suite, which comprises a highest order grouping of the unit tests, the test suite grouping containing at least one test case, each test case comprising a sub-grouping of said test suite.

Another aspect of the invention is a computer readable medium storing instructions, said instructions when executed by a computer system adapting said computer system to conduct the unit tests on the software application, the unit tests ordered under hierarchical groupings; and track the unit tests so as to capture a result of each unit test and a hierarchical position of each unit test within the groupings.

Yet another aspect of the invention is a computer system for testing a software application, comprising a central processing unit; and a memory storing instructions, said instructions, when executed by said central processing unit, adapting said computer system to conduct the unit tests on the software application, the unit tests ordered under hierarchical groupings; and track the unit tests so as to capture a result of each unit test and a hierarchical position of each unit test within the groupings.

Still another aspect of the invention is a system for tracking unit tests of a software application, comprising means for conducting unit tests on a software application, the unit tests ordered under hierarchical groupings; and means for tracking the unit tests so as to capture a result of each unit test and a hierarchical position of each unit test within the groupings. The system may further comprising means for outputting the hierarchical position of each unit test in association with the result. If at least one of the unit tests is iteratively conducted multiple times, the system may further comprise, each time said one of said unit tests is conducted, means for associating an iteration ordinal indication with a result obtained.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures illustrating example embodiments of the present invention,

FIG. 1 is a block diagram illustrating a computer system embodying aspects of the present invention;

FIG. 2 is a block diagram illustrating a portion of the computer system of FIG. 1;

FIG. 3 illustrates the hierarchy of an exemplary test executable on the computer system of FIG. 1;

FIG. 4 shows a UML (Universal Modeling Language) class diagram illustrating aspects of a known testing framework;

FIG. 5 shows a screen shot of sample results of the test of FIG. 3, tested using the framework of FIG. 4 with a textual test runner,

FIG. 6 shows a screen shot of sample results of the test of FIG. 3, also tested using the framework of FIG. 4 but with a graphical test runner;

FIG. 7 is a UML diagram illustrating aspects of the present invention;

FIG. 8 illustrates exemplary computer code implementing an aspect of the present invention;

FIGS. 9A-9B illustrate exemplary code implementing another aspect of the present invention;

FIGS. 10A-10B illustrate exemplary code implementing yet another aspect of the present invention;

FIG. 11 shows a screen shot of sample results of the test of FIG. 3, tested on the computer system of FIG. 1, with the textual runner of FIG. 4; and

FIG. 12 shows a screen shot of sample results of the test of FIG. 3, tested on the computer system of FIG. 1, with the graphical runner of FIG. 5.

### DESCRIPTION OF THE PREFERRED EMBODIMENT

In the drawings and the following description, like parts are given like reference numerals.

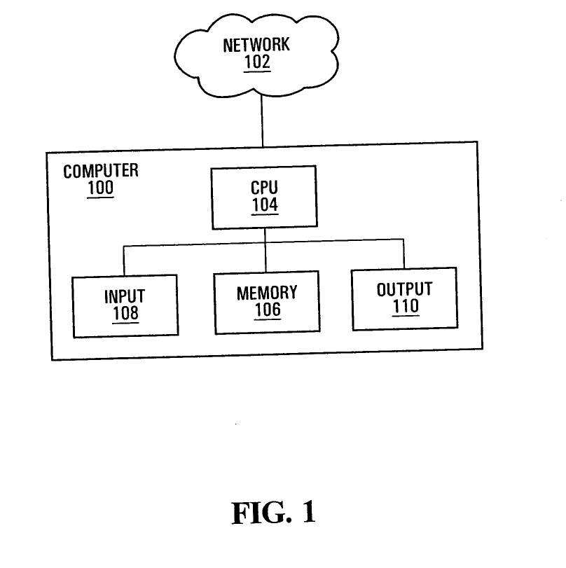

Referencing FIG. 1, a computer system 100 embodying aspects of the present invention may be optionally linked to a network 102. Computer system 100 may interact with other networked computer systems (not shown) to provide software application testing in a distributed manner. However, for the sake of clarity and conciseness, aspects of the present invention are illustrated as embodied solely on computer system 100 throughout the description herein. As will be appreciated by those of ordinary skill in the art, aspects of the invention may be distributed amongst one or more networked computing devices, which communicate and interact with computer system 100, via one or more data networks such as network 102. Network 102 may be embodied using conventional network technologies and may include one or more of the following: local area networks, wide area networks, intranets, the Internet, wireless networks, and the like.

Computer system 100 has a central processing unit (CPU) typically comprising a processor 104, which communicates with memory 106, input 108 and output 110. Processor 104 executes instructions stored in memory 106.

Memory 106 includes a primary electronic storage for processor 104 and may include one or more secondary stores, each of which comprises a computer readable medium. A computer readable medium can be any available media accessible by a computer, either removable or non-removable, either volatile or non-volatile. Such computer readable medium may comprise random-access memory (RAM) or read-only memory (ROM), or both. A RAM may be dynamic (DRAM) or static (SRAM). A ROM may include programmable ROM (PROM), erasable PROM (EPROM), and electrically erasable PROM (EEPROM) such as Flash Memory. By way of example, and not limitation, computer readable media include memory chip, memory card, magnetic cassette tape, magnetic cartridge, magnetic disk (such as hard disk and floppy disk, etc.), optical disc (such as CD-ROM, CD-R, CD-RW, DVD-ROM, DVD-R, and DVD-RW), Flash memory card (such as CompactFlash and SmartMedia card), memory stick, solid-state hard disk, and the like. Computer readable media also include any other magnetic storage, optical storage, or solid state storage devices, or any other medium which can embody the desired computer executable instructions and can be accessed, either locally or remotely, by a computer or computing device. Any combination of the above should also be included in the scope of computer readable medium.

Input device 108 may comprise, for example, a keyboard, a mouse, a microphone, a scanner, a camera, and the like. It may also include a computer readable medium and the corresponding device for accessing it.

Output device 110 may comprise, for example, display devices, printers, speakers, and the like. It may also include a computer writable medium and the device for writing to it.

It will be understood by those of ordinary skill in the art that computer system 100 may also include other, either necessary or optional, components not shown in the figure. By way of example, such other components may include elements of a CPU; network devices and connections, such as modems, telephone lines, network cables, and wireless connections; additional processors; additional memories; additional input and output devices; and so on. Further, two or more components of the computer system 100 may be embodied in one physical device. For example, a CPU 104 chip may also have built-in memory 106; a hard disk can be part of the memory 106, input device 108, and output device 110; and a touch screen display is both an input and an output device.

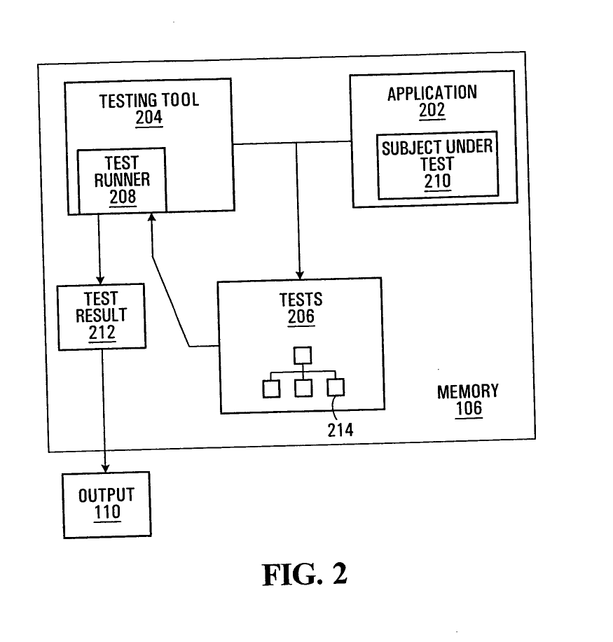

Referencing FIG. 2, stored on memory 106 are computer executable instructions for testing software applications 202. The instructions comprise testing tools 204 designed and implemented to facilitate the creation and execution of tests 206. Testing tools 204 may comprise an application package commonly known as a testing framework. Many conventional testing frameworks have been developed for creating and executing test cases and test suites. JUnit, for example, is a Java unit testing framework for creating and executing test cases and suites for Java applications. Other frameworks include for example MinUnit for C, CppUnit for C++, and NUnit for net applications. Testing tools 204 may include one or more test runners 208. A test runner 208 is a tool that loads and executes the tests 206 and outputs the test results 212 to output device 110.

Tests 206 are designed to test a portion or the whole of an application 202, often referred to as the subject under test 210. The subject under test can be any aspect of the application 202 a tester wishes to test. For example, to test a multi-user application, one subject under test could be a login procedure. Test 206 may comprise one or more unit tests 214, each of which tests only one modular aspect of the subject under test. For example, if the subject under test is a login procedure, one unit test 214 may test the opening of a dialog window and another unit test 214 may test the inputting of user name and password. To test a complex application, many, sometimes hundreds, of unit tests 214 may be used. Typically, multiple unit tests 214 within a test 206 are ordered under hierarchical groupings according to their relationship.

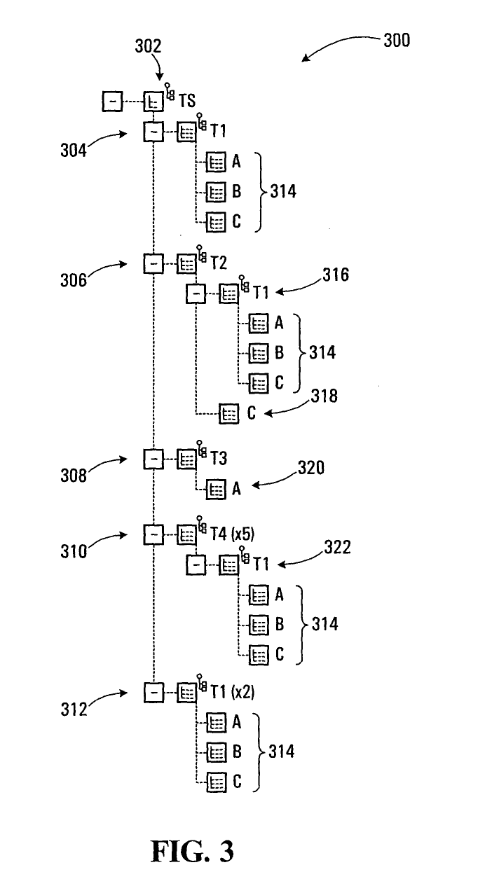

FIG. 3 illustrates the hierarchy 300 of an exemplary test, TS 302. Test TS 302 includes three unit tests, A, B, and C, executed in the following ordered sequence,

ABC ABCC A ABCABCABCABCABC ABCABC.

Each of the unit tests A, B and C can be an operation designed to test an aspect of the subject under test. For example, if the subject under test is a login procedure, unit test A could test the code for opening a login dialog window, unit test B could test the code for receiving input for a user name and a password, and unit test C could test the code for verifying or validating the user name and password.

As is customary, the unit tests are represented in hierarchical groupings in hierarchy 300. Under the top node TS 302 of the hierarchical tree 300, there are five nodes, tests T1 304, T2 306, T3 308, T4 310 (repeated five times), and T1 312 (repeated twice). One may consider test TS 302 as the parent of tests T1, T2, T3, and T4.

Test T1 304, 312, 316, and 322 has three children, unit tests A, B, and C. Test T2 306 has two children, test T1 316 and unit test C 318. Test T3 308 is the parent of one test, unit test A 320. Test T4 310, which is repeated five times, also has one child, test T1 322. While test T1 is consecutively executed seven times in tests T4 310 (T1 322) and T1 312, the last two iterations (T1 312) are distinguished from the previous five iterations (T1 322) because they have different parents, T4 310 and TS 302, respectively.

Iteration of a test is often necessary for a number of reasons. A system may require a load and stress test, in which the same action is repeated hundreds of times in a given time period to check if the system can handle the load. It may also be of interest to test how a database system would react when two entries are added to the database with the same primary key. Two iterations of the same test do not necessarily produce the same result due to changes in test environment or test parameters. For example, A test may fail only on even numbered iterations due to a bug in the code. In the login example described above, unit test C 314 may pass or fail depending on the input received in the preceding test, unit test B, which may be passed as a parameter to unit test C or cause a certain change in the system environment. (In principle, however, the result of a unit test should not depend on the pass or failure of a preceding unit test.) For example, unit test C may fail because the username or password consists of unacceptable characters. In a client-server application, unit test C may also pass the first time but fail the second time if, during the interval between the two iterations, the server has crashed, or a communication channel between the client and the server has become so congested that a time-out has been reached before a response can be received.

Tests 206 such as TS 302 may be implemented using test cases and test suites. A test case describes the subject under test and items to be tested. A test case may comprise one or more unit tests, test cases or a combination of both. A test suite is essentially a collection of test cases. Thus, tests T1, T2, T3 and T4 are test cases and test TS is a test suite.

From the above description, it may be appreciated that each node of the test hierarchy 300 is a test: the top node is a test suite; the intermediate nodes are test cases; and the terminal nodes are unit tests 214. Each unit test 214 descends from a chain of nodes forming a branch of the hierarchical tree 300. For ease of description, a branch of a hierarchy is represented herein with a text string of the following format:

TestSuiteName_#>TestCaseName_#>. . . >UnitTestName_#,

where TestSuiteName is the name of the test suite at the top node, TestCaseName is the name of the test case at an intermediate node, UnitTestName is the name of the unit test at the terminal node, and # is an iteration ordinal indication, which can be an integer or other sequential numbers. The test preceding a “>” sign is the parent of the test following the “>” sign. Thus, for instance, the first branch of hierarchy 300 (that is, the execution of unit test A in test T1 304) is represented as “TS_{—}1>T1_{—}1>A_{—}1” and the third iteration of unit test B in T4 310 is represented as “TS_{—}1>T4_{—}3>T1_{—}3>B_{—}3”.

Test cases and test suites are generally implemented using test scripts. While test cases and test suites can be implemented in any scripting or programming language compatible with the particular testing tools used, in this description, exemplary test cases and test suites are implemented using test scripts in Java language for illustrative purposes.

To assist the understanding of the exemplary embodiments of the present invention described herein, a brief description of a known JUnit framework is given next.

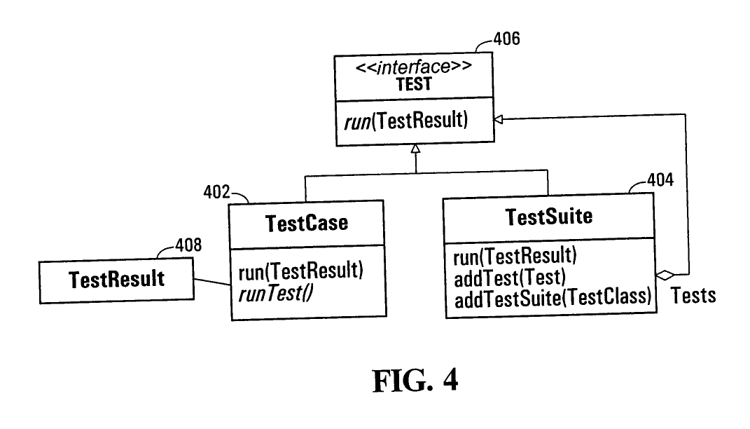

Referencing FIG. 4, the two main classes of the known JUnit framework are the TestCase class 402 and TestSuite class 404, both of which implements the Test interface 406. Test interface 406 specifies the methods that a conforming class must define, including methods for running a unit test and for collecting test results in an instance of TestResult 408.

Within the JUnit framework, test cases are defined using the TestCase class 402, which encapsulates the logic of a test case and has, among others, the following methods:

TestCase class

| Method | Comment |
|---|---|
| Test methods | Each method implements the logic of a unit test. |
| | If a TestCase class does not provide a suite( ) method (see |
| | below), all test methods in the class whose names start with |
| | “test” are executed in the sequence of their creation. |
| suit | Allows execution of selected test methods in the class and |
| | execution of other test cases or test methods in other |
| | TestCase classes. |
| | Test cases can be recursively composed of cases of cases |
| | using the “suite” method. |
| run | Executes this test and collects the results with a default or |
| | specified TestResult object. |
| runTest | Run a test and assert its state. |
| setName | Sets the name of a test case. |
| getName | Gets the name of the test case. |
| toString | Returns a string representation of the test case. This string |
| | contains the name of the test object and its source. |

The TestSuite class 404 is used for implementing test suites. A test suite is a composite of tests. It runs a collection of test cases. An instance of TestSuite 404 can run only tests specifically added to the suite or can extract the tests to be run automatically from a specified test class. TestSuite class 404 has, among others, the following methods:

TestSuite class

| Method | Comment |
|---|---|
| addTest | Adds a test case or a test method to the suite. |
| addTestSuite | Adds all the test methods in the specified test class to the |
| | suite. |
| testCount | Returns the number of test cases in the suite. |

The TestSuite class also has methods similar to those in the TestCase class, such as “run”, “runTest”, “setName”, “getName”, and “toString” etc.

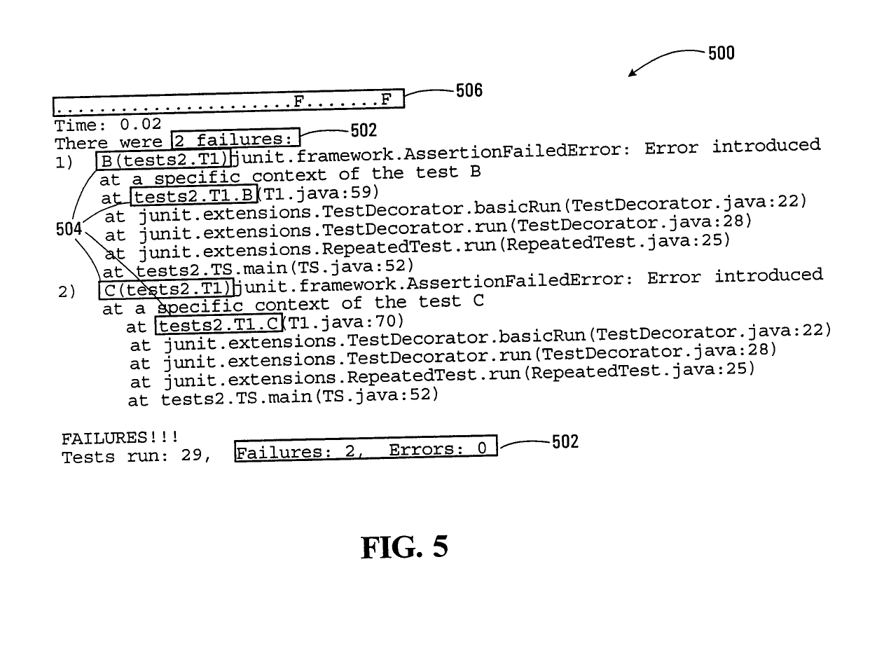

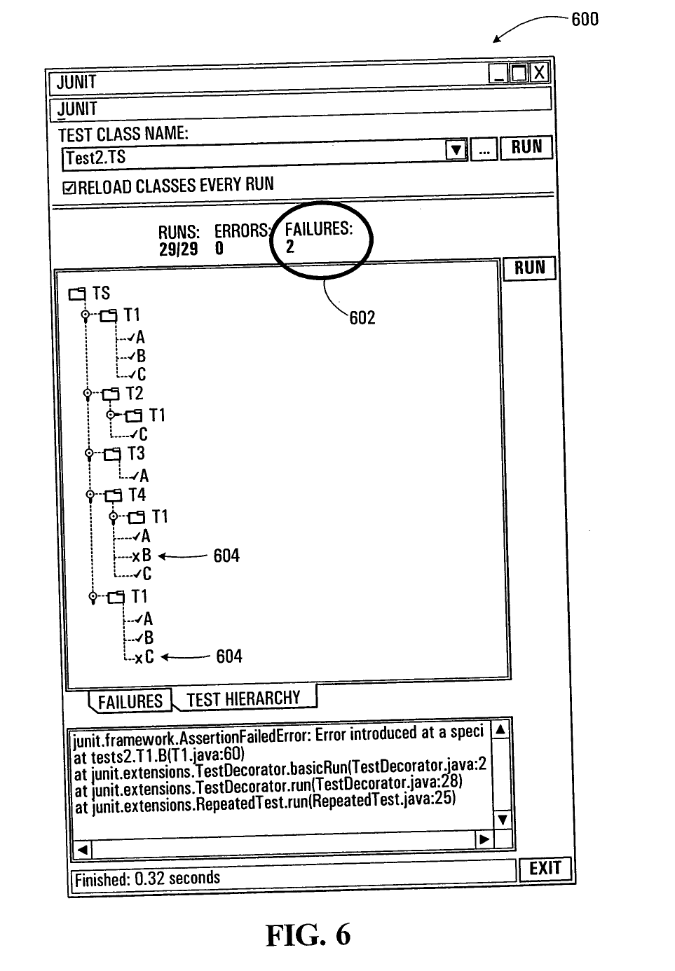

As alluded to above, the results of a test are placed in a TestResult object. The conventional JUnit framework comes with different implementations of TestResult. The default implementation counts the number of failures and errors and collects the results. For example, the TestResult class 408 may be instantiated to collect the results and present them in a textual form (see FIG. 5). The UITestResult class may be used by graphical test runners to update the graphical test status (see FIG. 6).

Returning to FIG. 3, test T1 may be implemented in Java as a test case for use with JUnit, using the exemplary code partially illustrated in Appendix I. As illustrated, class T1 is a subclass of the TestCase class 402. In class T1, a Test named “T1” is defined. Test T1 includes three unit tests A, B, and C, which are respectively defined in class T1 as methods A, B and C. It is understood that one or more of the methods implementing unit tests A, B, and C may be defined in another class or test script.

In order to demonstrate the operations of the known JUnit and the embodiments of this invention, two failures are arbitrarily introduced to test TS 300, one at TS_{—}1>T4_{—}5>T1_{—}5>B_{—}5, which is the seventh execution of unit test B, and one at TS_{—}1>T1_{—}2>C_{—}2, which is the tenth execution of unit test C. The two failure conditions are implemented in method B and method C of class T1 as partially illustrated in Appendix I. As conventional in the field of software testing, an error is distinguished from a failure in that, while both will cause the test to fail, a failure is anticipated (often intentionally introduced by the test designer) whereas an error is unexpected.

Similarly, one can define test case T2, which executes test case T1 and unit test C as defined by method C in class T1 (as conventional in Java language, method C of class T1 may be referred to as “T1.C”) using exemplary code partially illustrated in Appendix II; test case T3, which executes method T1.A, as illustrated in Appendix III; and test case T4, which executes test case T1 five times, as illustrated in Appendix IV. Partial exemplary code implementing test suite TS is illustrated in Appendix V.

As will be understood by a person skilled in the art, there are alternative ways of implementing test TS 302. For instance, the methods implementing unit tests A, B and C may be defined in a test script other than the one that implements test case T1, or in a TestCase class other than the T1 class, so long as the argument of the “addTest” method points to the correct test class. Further, as mentioned, if a method in a test case class has a name starting with “test”, e.g. “testA”, it will be automatically included in the suite when the class is added to the suite using the addTestSuite method. Thus, it is not necessary to explicitly add each test case or unit test to the suite using the addTest method. Repeated tests can also be alternatively implemented. For example, instead of using RepeatedTest method, consecutive addTest statements may be used. In addition, the T4 test case may invoke the RepeatedTest in the argument of “addTest”, instead of invoking it in the “return” statement.

From the exemplary code illustrated, it may be appreciated that for each branch of the tree 300, the tests are executed sequentially from the top node to the terminal node, where when the test at each node is executed, a new object implementing Test 406 is instantiated. The top node is an instance of the TestSuite class whereas the lower nodes are instances of the TestCase class.

Conventionally, unit test frameworks provide test results which indicate whether and how many failures and errors have occurred during the execution of a test suite. For example, the existing JUnit framework provides results of tests through instances of the TestResult class 408. FIGS. 5 and 6 illustrate example screen shots 500 and 600 of the results of executing the exemplary test suite TS 300, as implemented above, on a known JUnit framework. FIG. 5 shows the result of running the test with a textual runner. FIG. 6 shows the result of running the test with a graphical runner. In both cases, it is indicated that two failures had occurred (see text blocks 502 and 602).

The identification of the test methods that failed provides sufficient information to allow for effective unit testing. However, we have recognized that the test cases and test suites created for unit testing can be used in higher level testing, e.g., in one or more of component testing, functional testing, system testing and integration testing, if the locations of the unit test failures are precisely provided. Existing unit test frameworks do not provide this information clearly, conveniently and efficiently. For example, the test results provided by existing JUnit do not explicitly indicate where in the execution hierarchy and which iteration of a test produced a failure.

As illustrated in FIG. 5, the result 500 explicitly indicates that two failures have occurred (see text blocks 502). It also indicates (see text blocks 504) that one failure occurred during an execution of unit test B (as implemented in the method T1.B) and another during an execution of unit test C (as implemented in the method T1.C). However, since unit test B (i.e. method T1.B) is executed nine times and unit test C (method T1.C) ten times in TS 302, it is not clear exactly at which branch and which iteration the failures occurred. While one may count the dots in text block 506 (where each dot represents a test run and an “F” indicates a failure) and calculate the exact location and iteration of the failed tests, this is very inconvenient even in simple tests. It becomes impractical when the test has a complicated structure and includes hundreds of iterated unit tests.

FIG. 6 shows a sample result 600 of the same test executed with a graphical runner. Text block 602 indicates that there are two failures. In addition, the result 600 includes a graphical representation of the test hierarchy 300, on which the failure locations are indicated as crosses 604. As shown, one failure occurred at TS_?>T4_?>T1_?>B_? branch and the other at the bottom TS_?>T1_?>C_? branch. However, from this result, it is not clear at which iterations the failures occurred.

Determining the failure location and iteration is not overly problematic for many testers at the early stages, particularly the unit testing stage, of application development. The structures of tests at an early stage are usually simple and the testers usually wrote the test scripts and the code for the subject under test themselves or were otherwise intimately involved in the development of the test scripts and the application code, so that they know the structures of the tests quite well and it is not difficult for them to figure out the exact location of a particular failure. However, at the later testing stages, the test suites often have complex structures and the testers often do not know the test scripts, nor the code of the application under test, well enough to independently identify failure locations.

Thus, in order to use existing unit testing tools and test scripts in the later stages of testing, it is desirable to modify the existing unit testing tools to provide clear indications of failure location. A possible approach to do so is to modify the test runners 208. A given test may be run with different runners. While the test results are runner independent, the visual representation of the test results may vary from runner to runner, as already illustrated above and in FIGS. 5 and 6. It is therefore possible to construct runners that provide the desired failure information, again as partially demonstrated in FIGS. 5 and 6.

However, modifying runners has at least three drawbacks. First, to provide this additional information, all existing runners have to be modified. Second, the modification of a runner can be expensive, difficult, and even impractical such as when the source code of the runner is unavailable. Third, as each runner developer may choose its own representation of the desired information, the representation formats may not be uniform. It is therefore preferable to provide the desired additional information without reliance on test runners.

Embodiments of the present invention include testing tools that provide a way of tracking unit tests so as to capture the hierarchical information and iteration information without the need to modify existing runners.

In the exemplary embodiments of the present invention described below, a known JUnit framework (referred to as non-extended JUnit hereinafter) is extended to include methods for capturing the name of the current test, the name of the parent of the current test, and the ordinal number of the iteration of the current test (the modified framework is referred to as the extended JUnit hereinafter). The information is captured before each iteration of a test case is executed. The captured information is then embedded in a text string that represents the current test case. Since the string representing the test case is by default included in the test result held by the TestResult object, the information is transparently passed on to the test runner and will be displayed in a uniform manner, which may be enforced by the extended Test interface. This and other advantages of this approach can be appreciated by a person skilled in the art from the following description.

A particular implementation of this approach is described next. In the following, exemplary modifications are described using example source code. However, some portions of the source code are not explicitly described or explained because persons skilled in the art would understand the functions of these portions, that these functions should or may be included, and the manner in which these functions may be implemented. For example, it would be understood that it is a good programming practice to check for a null string before performing an operation on a string.

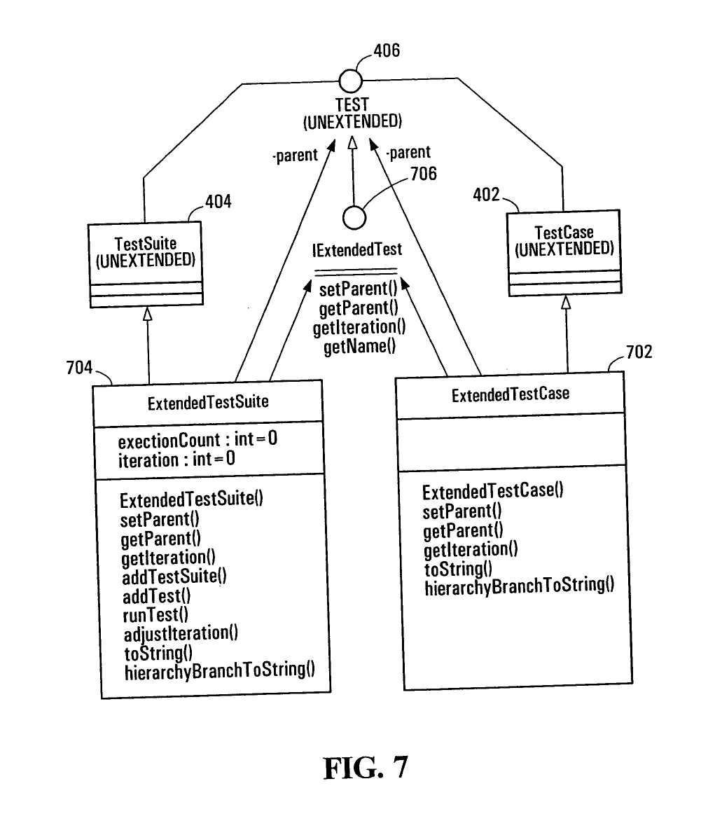

In this particular implementation, two classes, the TestCase class 402 and the TestSuite class 404 are modified (extended), as illustrated in FIG. 7. From FIG. 7, it will also be apparent that the Test interface 406 may be modified.

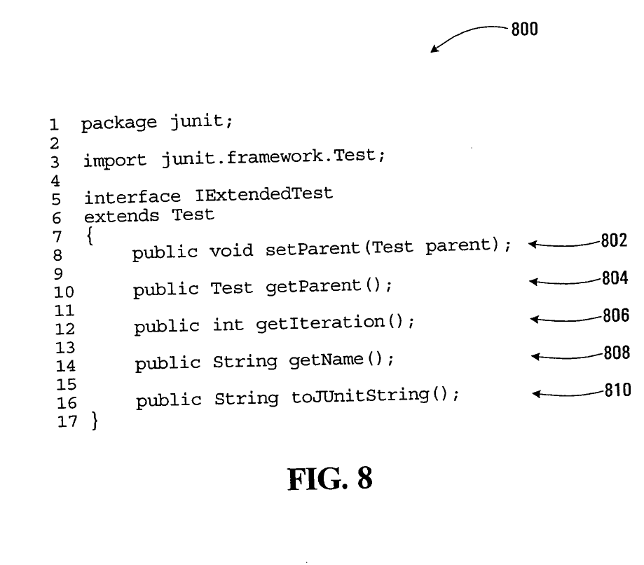

Specifically, the interface IExtendedTest 706 defines the extended Test interface (extending the interface Test 406). An exemplary code 800 implementing interface IExtendedTest 706 is illustrated in FIG. 8. This extension ensures that all implementations of interface IExtendedTest 706 would be compliant with the extended JUnit (with the additional information about the parent, the current iteration ordinal and the name of the test embedded in the string representing the test (toString)) regardless of whether the test runner used implements the extended features. Thus, all existing runners of non-extended JUnit may be used with the extended JUnit without modification. However, existing test scripts created with non-extended JUnit need to be modified in order to implement IExtendedTest interface 706. The modifications are nonetheless quite simple and can be automated as will become apparent from the following description.

As is understood by persons skilled in the art, in Java language, an interface specifies the methods each conforming class must define. Referring to exemplary code 800 in FIG. 8, interface IExtendedTest 706 specifies the methods that must be defined in each test class. Text block 802 (line 8) specifies a method that sets the parent for the current test (setParent); block 804 (line 10) specifies a method that returns the name of the parent (getParent); block 806 (line 12) specifies a method that returns the current iteration ordinal indication of the current test (getiteration); block 808 (line 14) specifies a method that returns the name of the current test (getName); and block 810 (line 16) specifies a method that defines a new string (toJUnitString), the use of which will become clear below.

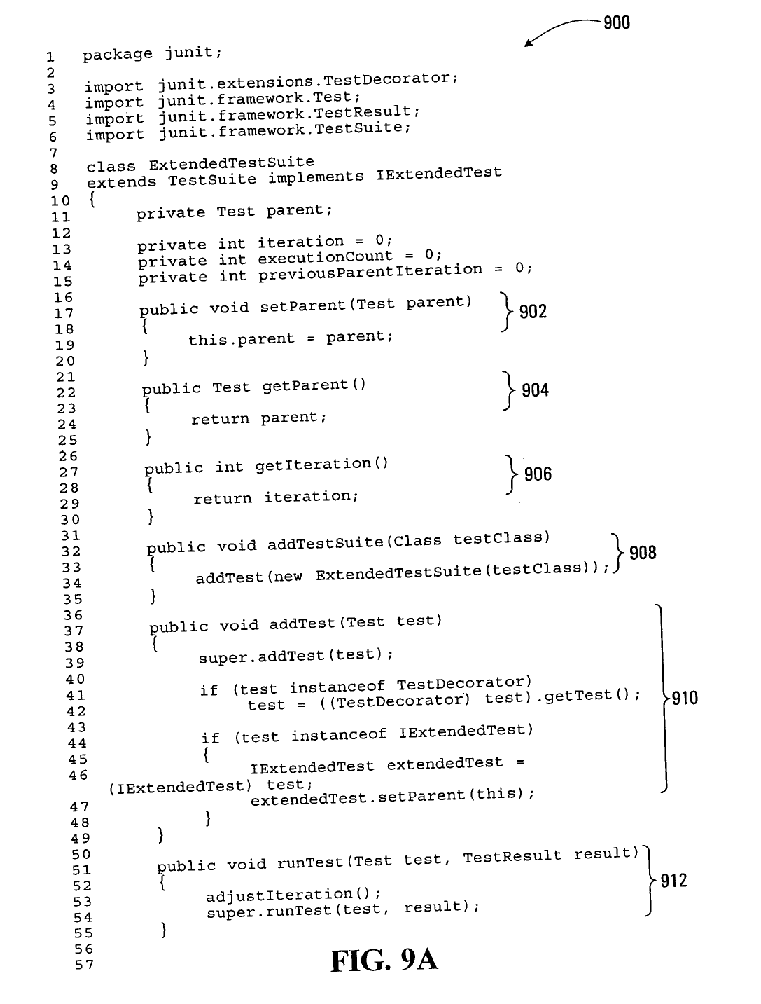

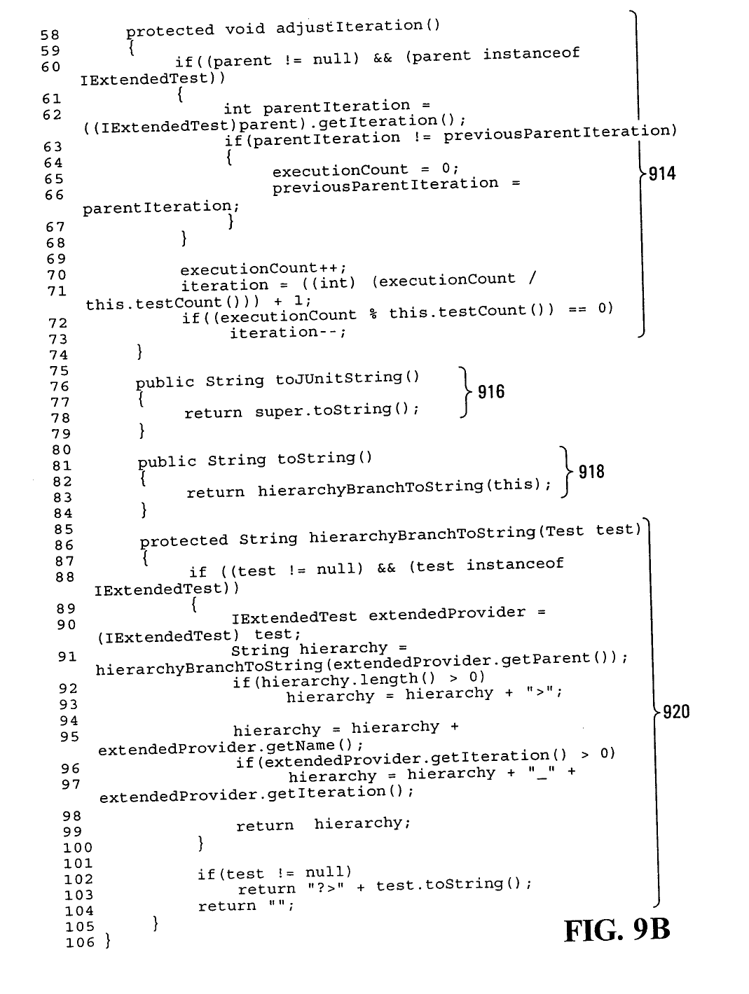

Referring to FIGS. 9A-9B, the extendedTestSuite class 704 implemented in the exemplary code 900 extends the TestSuite class 404 to provide the expected behavior specified in the IExtendedTest 706 interface.

Specifically, the methods of setParent (text block 902), getParent (block 904), and getiteration (block 906) are added. Further, three methods addTestSuite (block 908), addTest (block 910), and runTest (block 912) are redefined. Redefined runTest (block 912) now executes a new, added method adjustIteration (block 914). The string representing test cases is defined using a redefined toString method (block 918), which in turn includes a new string hierachyBranchToString (block 920). The above modifications provide the methods to capture the desired additional information.

More specifically, the redefined addTest(Test) method (block 910) first calls the addTest method defined in the unextended TestSuite class and then sets the current test suite as the parent of the added test, if the added test implements the IExtendedTest interface (line 44, as understood by persons skilled in the art, in Java language if an object is an “instanceof” an interface then the object implements the interface). As can be appreciated, a test suite is transparently set as the parent of any test case executed by the test suite.

The redefined runTest method (block 912) sets the iteration ordinal of a test before actually running the test, using the following logic (see block 914).

The iteration counter (“iteration”) of the current test is calculated as (line 70-73):

$$iteration = \{ \begin{matrix}int ( executionCount / testCount ) , & if mod ( executionCount / testCount ) = 0 \\ int ( executionCount / testCount ) + 1 , & other wise \end{matrix}$$

where testCount is the number of tests to be executed in the current test and executionCount is the number of tests that have already been executed. The executionCount is incremented by one before each execution of a test (line 70). For example, in FIG. 3, test T1 (312) has three children, thus, testCount=3. Assuming that unit tests A and B have been executed once each, executionCount=2. Therefore, iteration=int(2/3)+1=1 (since mod(2/3)=2), which means it is the first iteration of T1. Next unit test C is executed and executionCount=3, then iteration=(3/3)=1 (since mod(3/3)=0). It is still the first iteration of T1. The next execution is the second execution of unit test A and fourth overall. Hence, executionCount=4 and iteration=int(4/3)+1=2. It is the second iteration of test T1.

The execution counter is set to zero when a new object of ExtendedTextSuite 604 is instantiated (line 14). The execution counter is also reset to zero when the current test has a parent which implements IExtendedUnit test and whose iteration counter has changed since last time the iteration counter of the current test was set (lines 60-68). This ensures that the iteration ordinal of the current test will be reset to 1 when the parent test begins a new iteration. For example, assuming that TS 302 is iterated twice, when TS 302 begins its second iteration, the execution counter of T1 (312) would be reset so that the counter only counts the tests that have been executed during the second iteration of the parent, test TS 302.

As will be understood by a person skilled in the art, the logic described above is merely one of many possible ways of calculating or tracking the iteration ordinal indication of tests. This logic, and its particular implementation illustrated herein, is described only for illustration purposes.

When each test is executed, or in other words, when each test object is instantiated, the parent and iteration information about the test is embedded in the standard Java output string toString representing the test object. During execution, any time when a system output from the test object is requested, the toString method of the test object is called (executed). The content of the toString as defined in the unextended TestSuite class is preserved in the toJUnitString (blocks 916). The redefined toString method in the extendedTestSuite class returns a new string called hierarchyBranchToString (block 918). The string returned by hierarchyBranchToString(currentTest) is constructed similarly for both test cases and test suites, as follows (block 920).

If there is a parent, the parent's hierarchyBranchToString (i.e., hierarchyBranchToString(parent) is added to the string (line 91) followed by a “>” sign (lines 92-93). If there is no parent, nothing is added. In either case, the name of the currentTest is added to the end of the string (line 95). If the iteration of the currentTest is greater than zero (i.e., it has been executed at least once), a “_” sign is added and followed by the iteration ordinal (lines 96-97). The string is then returned as hierarchyBranchToString(currentTest). For example, if the current test is the first iteration of TS 300, there is no parent and the hierarchyBranchToString(TS) would return a string “TS_{—}1”. Next, test case T1 304 is executed, hierarchyBranchToString(T1) would return a string “TS_{—}1>T1_{—}1”. The next test to be executed is unit test C 314. The parent is T1, and the string returned would be “TS_{—}1>T1_{—}1>C_{—}1”. The string is only constructed this way when the current test implements IExendedTest (lines 88-100). Otherwise, the string returns “?>” followed by the default toString of the current test. For example, “?>testD”.

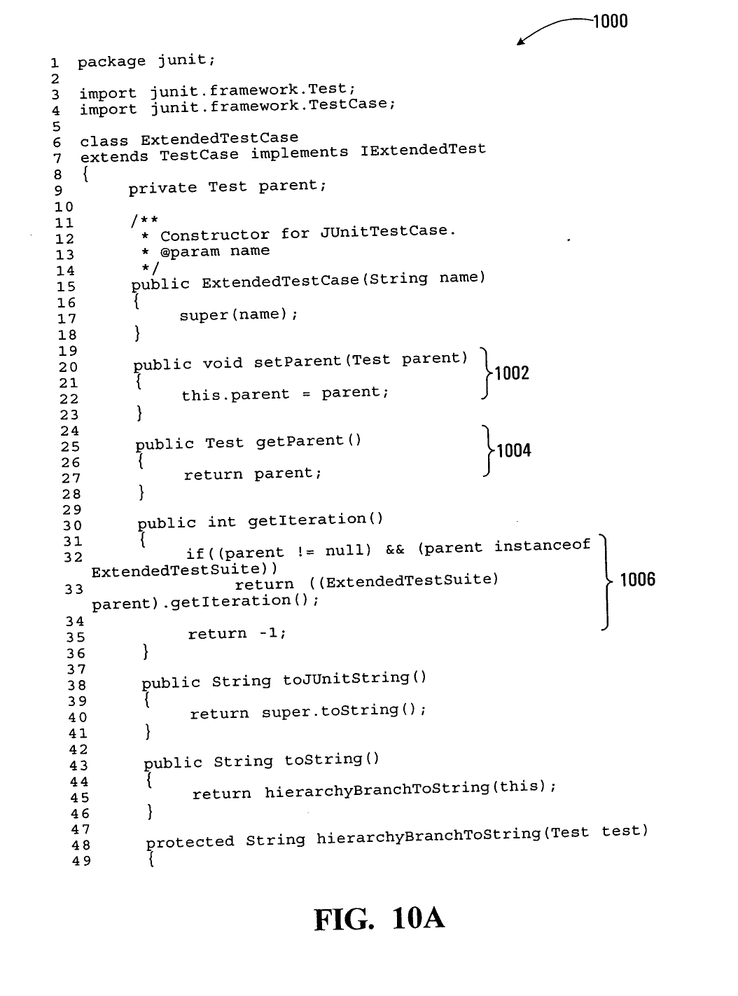

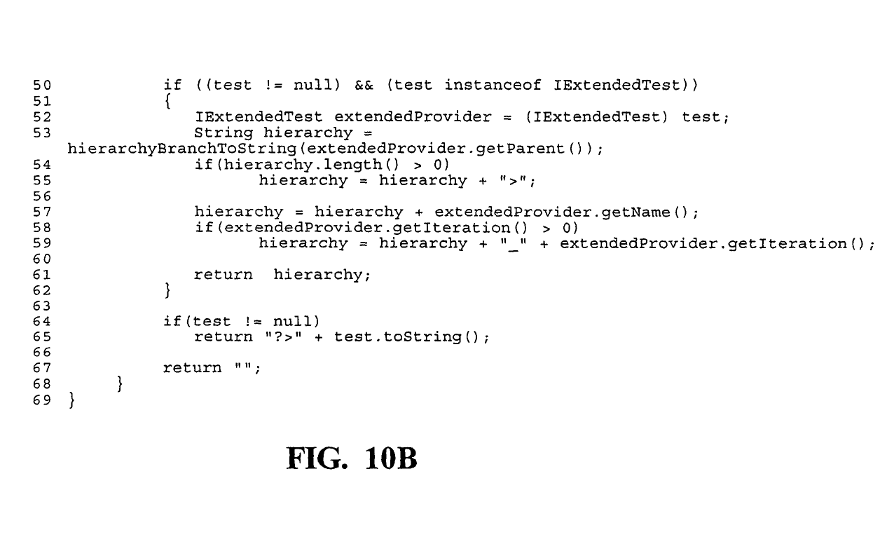

Referring to FIG. 10, the extendedTestCase class 702 implemented in exemplary code 1000 extends the TestCase class 402 by, in part, defining the methods setParent (block 1002) and getParent (block 1004) and the string methods toJUnitString, toString, and hierarchyBranchToString (lines 43-68) similarly as in the extendedTestSuite class 704. However, the getIteration method (block 1006) is defined differently. The iteration of a test in a test case is set the same as its parent if the parent has a non-null name and is an instance of the extendedTestSuite class (lines 32-33). Otherwise, the iteration cannot be calculated and is initially set to minus one (−1) (line 35). This method provides a convenient way of getting the iteration count from the parent.

As can be appreciated, in this exemplary embodiment, the iterations of tests in a test case is not separately and individually tracked and captured. Tests in test cases inherit iteration counts from their parents. It is possible to also track and capture iteration ordinal indications of tests in test cases separately and individually, which can be easily implemented by a person skilled in the art using a logic similar to that for the test suite. However, while other embodiments are possible, the exemplary embodiment described above has several advantages. It encourages the test designers to adhere to a design principle of JUnit framework: use test cases for simple grouping of unit tests and use test suites for complex groupings and repetitive testing. It is also easy to implement.

The captured parent and iteration information may be represented and passed to the output 110 in other manners as well. For example, the string representing the test object (toString) may be formatted differently as described above. A more specific example is that the signs “>” and “_” may be replaced with any other suitable symbols, letters, words, or combinations of these. While decimal integers are convenient to use, the iteration ordinal indication may be represented by other sequential symbols instead of Arabic numbers or in other counting systems instead of the decimal numbers. For example, letters or binary numbers may be used. The test object may also be represented in whole or in part in graphical form. One advantage of the embodiment described above is that the information is presented or displayed in a uniform manner on different output devices 110 and with different test runners 208.

As can be appreciated, the modification to the JUnit framework is minimal and can be easily implemented. Since both parent and iteration information is captured and recorded transparently there is no need to modify existing test runners in order to use them to run tests under the extended JUnit. There is also no need to add additional code to existing test scripts for the scripts to be executable under the extended JUnit, except for modifications to invoke the three extended classes instead of the non-extended classes, as will be described next.

Modification of test scripts created under the non-extended JUnit for execution under the extended JUnit is simple and straightforward. For example, the following table summarizes the changes made to the exemplary code of Appendices I to V, in order to implement test TS 302 for execution under the extended JUnit described herein. The resulting exemplary code is partially illustrated in Appendices VI to X.

| Type of modification | TestCase Class | TestSuite Class |
|---|---|---|
| Modify package name | new name: extendedTests | new name: |
| | | extendedTests |
| New Imported Java files | ExtendedTestCase; | ExtendedTestSuite |
| | ExtendedTestSuite | |
| Replace any new | Replace “TestCase” with | |
| TestCase class with | “ExtendedTestCase” in | |
| ExtendedTestCase | each phrase that contains | |
| class | “extends TestCase” | |

| | |
|---|---|
| Replace any new | Replace “TestSuite” with “ExtendedTestSuite” |
| instance of TestSuite | in each phrase that contains “new TestSuite” |
| class with instance of | |
| ExtendedTestSuite class | |

As can be appreciated, these modifications of the test script can be automated by replacing certain lines of code, adding new lines of code, and replacing certain phrases.

Other modifications to these and other classes of the JUnit and the test scripts may be made to provide additional features, additional functionality, or convenience, as will be understood by persons skilled in the art.

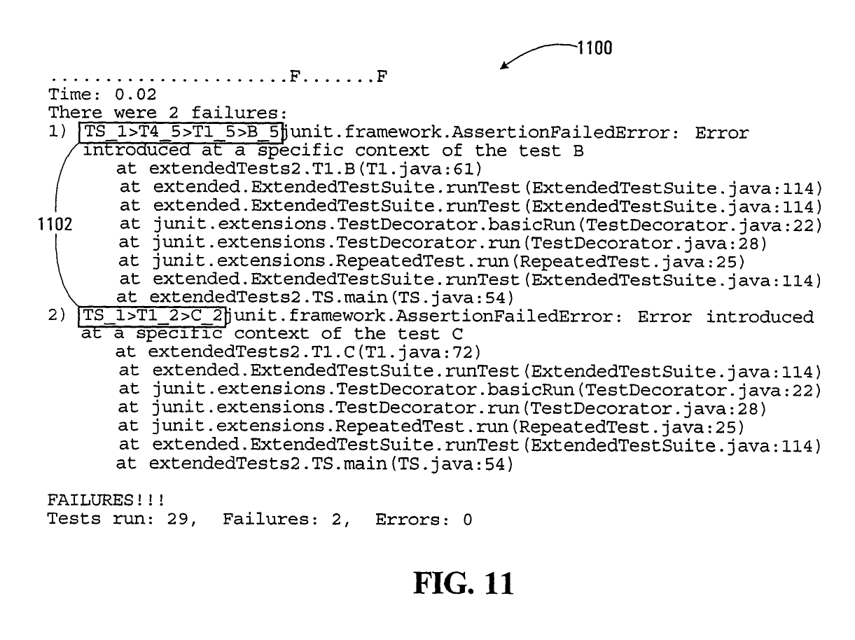

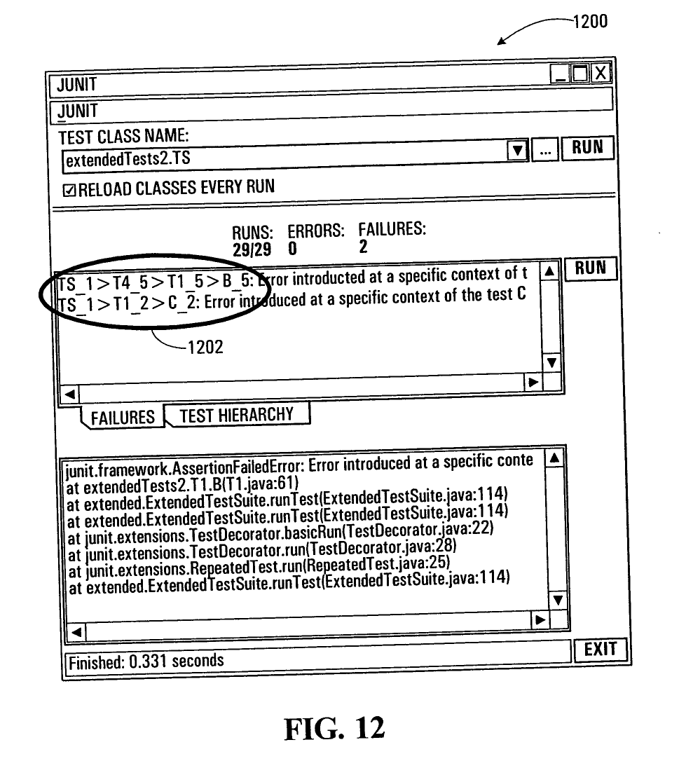

The results of executing TS 302 using the extended JUnit are shown in FIGS. 11 and 12. FIG. 11 shows the screen shot 1100 of results of the test executed by the textual runner of FIG. 5. FIG. 12 shows the screen shot 1200 of results of the test executed by the graphical runner of FIG. 6. As can be seen, the parent and iteration information is clearly presented in text blocks 1102 and 1202.

While in the exemplary embodiments described above, the Test interface 406 has been modified, this modification is not necessary, as long as all test suites and test classes include the methods defined in the IExtendedTest 706 interface and appropriate changes are made to the extendedTestSuite 704 and extendedTestCase 702 classes. It is, however, a good programming practice to modify the interface to enforce the behavior of conforming classes.

The embodiment of this invention is described above in the context of test failures. However, the captured hierarchical and iteration information may be used in other contexts or associated with other events of testing.

In the exemplary embodiments described above, for simplicity reasons, the iteration indicator of a test only indicates the number of consecutive executions. Non-consecutive executions are not distinctively identified in the output. For example, T1 304 is not differentiated from T1 312. The first execution of either one of them is represented by the string “TS_{—}1>T1_{—}1.” It is possible to include, e.g. in toString, an indication of the number non-consecutive executions of a test, such as “TS_{—}1>T1(1)_{—}1” for T1 304 and “TS_{—}1>T1(2)_{—}1” for T1 312.

As will be appreciated, the exemplary extended testing framework described herein provides clear, precise, and consistent representation of the hierarchical and iteration information of unit tests, without the need to modify test runners. The additional hierarchical and iteration information is readily available at any steps of the execution. Implementing the extended testing framework is simple and straightforward. Therefore, existing unit testing tools and unit test scripts can be used in a higher testing stage such as component testing or system testing with easy and minimal modifications of the unit testing framework and test scripts.

Other features, benefits and advantages of the present invention not expressly mentioned above can be understood from this description and the drawings by those skilled in the art.

Although only a few exemplary embodiments of this invention have been described above, those skilled in the art will readily appreciate that many modifications are possible therein without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents but also equivalent structures.

APPENDIX I
Portion of an exemplary test script for TestCase class T1.

```
package tests
...
public class T1 extends TestCase
{
    private static int bCounter=0;
    private static int cCounter=0;
    ...
    public static Test suite( )
    {
        TestSuite testSuite = new TestSuite(“T1”);
        testSuite.addTest (new T1(“A”));
        testSuite.addTest (new T1(“B”));
        testSuite.addTest (new T1(“C”));
        return testSuite;
    }
    public void A( )
    {
        /* define operation of unit test A */
        ...
    }
    public void B( )
    {
        bCounter++;
        if (bCounter == 7)
        {
        assertNotNull(“Error introduced at a specific context of the test
        B”, null);
        }
        /* define other operation of unit test B */
        ...
    }
    public void C( )
    {
        cCounter++;
        if (cCounter == 10)
        {
        assertNotNull(“Error introduced at a specific context of the test
        C”, null);
        }
        /* define other operation of unit test C */
        ...
    }
    ...
}
```

APPENDIX II
Portion of an exemplary test script for TestCase class T2.

```
...
public class T2 extends TestCase
{
    ...
    public static Test suite( )
    {
        TestSuite testSuite = new TestSuite(“T2”);
        testSuite.addTest (T1.suite( ));
        testSuite.addTest (new T1(“C”));
        return testSuite;
    }
}
```

APPENDIX III
Portion of an exemplary test script for TestCase class T3.

```
...
public class T3 extends TestCase
{
    ...
    public static Test suite( )
    {
        TestSuite testSuite = new TestSuite(“T3”);
        testSuite.addTest (new T1(“A”));
        return testSuite;
    }
}
```

APPENDIX IV
Portion of an exemplary test script for TestCase class T4.

```
...
public class T4 extends TestCase
{
    ...
    public static Test suite( )
    {
        TestSuite testSuite = new TestSuite(“T4”);
        testSuite.addTest (T1.suite( ));
        return new RepeatedTest(testSuite, 5);
    }
}
```

APPENDIX V
Portion of an exemplary test script for TestSuite class TS.

```
...
public class TS extends TestSuite
{
  ...
  public static Test suite( )
  {
    TestSuite testSuite = new TestSuite(“TS”);
    testSuite.addTest (T1.suite( ));
    testSuite.addTest (T2.suite( ));
    testSuite.addTest (T3.suite( ));
    testSuite.addTest (T4.suite( ));
    testSuite.addTest (new RepeatedTest(T1.suite( ), 2);
    return testSuite;
  }
  public static void main (String[] arguments)
  {
  /*
  * some statements for invoking a selected test runner to run the test TS
  */
  ...
  }
  ...
}
```

APPENDIX VI
Portion of an exemplary test script for ExtendedTestCase class T1.

```
package extendedTests;
...
import extended.ExtendedTestCase;
import extended.ExtendedTestSuite;
public class T1 extends ExtendedTestCase
{
    ...
    public static Test suite( )
    {
        TestSuite testSuite = new ExtendedTestSuite(“T1”);
        extendedTestSuite.addTest (new T1(“A”));
        extendedTestSuite.addTest (new T1(“B”));
        extendedTestSuite.addTest (new T1(“C”));
        return testSuite;
    }
    public void A( )
    {
        ...
    }
    public void B( )
    {
        ...
    }
    public void C( )
    {
        ...
    }
    ...
}
```

APPENDIX VII
Portion of an exemplary test script for ExtendedTestCase class T2.

```
...
public class T2 extends ExtendedTestCase
{
    ...
    public static Test suite( )
    {
        TestSuite testSuite = new ExtendedTestSuite(“T2”);
        testSuite.addTest (T1.suite( ));
        testSuite.addTest (new T1(“C”));
        return testSuite;
    }
}
```

APPENDIX VIII
Portion of an exemplary test script for ExtendedTestCase class T3.

```
...
public class T3 extends ExtendedTestCase
{
    ...
    public static Test suite( )
    {
        TestSuite testSuite = new ExtendedTestSuite(“T3”);
        testSuite.addTest (new T1(“A”));
        return testSuite;
    }
}
```

APPENDIX IX
Portion of an exemplary test script for ExtendedTestCase class T4.

```
...
public class T4 extends ExtendedTestCase
{
    ...
    public static Test suite( )
    {
        TestSuite testSuite = new ExtendedTestSuite(“T4”);
        testSuite.addTest (T1.suite( ));
        return new RepeatedTest(testSuite, 5);
    }
}
```

APPENDIX X
Portion of an exemplary test script for ExtendedTestSuite class TS.

```
...
import extended.ExtendedTestSuite;
public class TS extends ExtendedTestSuite
{
    ...
    public static Test suite( )
    {
        TestSuite testSuite = new ExtendedTestSuite(“TS”);
        testSuite.addTest (T1.suite( ));
        testSuite.addTest (T2.suite( ));
        testSuite.addTest (T3.suite( ));
        testSuite.addTest (T4.suite( ));
        testSuite.addTest (new RepeatedTest(T1.suite( ),2);
        return testSuite;
    }
    public static void main (String[] arguments)
    {
    ...
    }
    ...
}
```

What is claimed is:

1. A method for tracking unit tests of a software application, said method comprising the steps of:
(a) conducting unit tests on a software application, said unit tests ordered under hierarchical groupings; and
(b) tracking said unit tests so as to capture a result of each of said unit tests and a hierarchical position of each of said unit tests within said hierarchical groupings.

2. The method of claim 1, further comprising the step of:
(c) outputting the hierarchical position of each of said units test in association with the corresponding result.

3. The method of claim 1, wherein at least one of said unit tests is iteratively conducted multiple times, and said method further comprises the step of:
(d) each time one of said unit tests is conducted, associating an iteration ordinal indication with the result obtained.

4. The method of claim 1, wherein said unit tests are grouped within a test suite, said test suite comprising a highest order grouping of said unit tests, said test suite grouping containing at least one test case, each test case comprising a sub-grouping of said test suite.

5. The method of claim 4, wherein a sub-set of said unit tests is grouped within one test case.

6. The method of claim 5, wherein one or more other test cases are grouped within said one test case, each of said other test cases comprising a sub-grouping of said one test case.

7. The method of claim 6, wherein at least one of said other test cases is iteratively conducted.

8. The method of claim 3, wherein said associating step further comprises instantiating at least one of a test case class and a test suite class, said test case class and said test suite class being associated with methods for, in respect of a given unit test, getting a parent of a sub-grouping to which said given unit test belongs and any iteration ordinal.

9. The method of claim 8, wherein said test case class extends a test case class and said test suite class extends a unit test suite class.

10. The method of claim 9, wherein said unit tests are conducted by an instantiation of a runner within an instantiation of a framework, said test case class and said test suite class being part of said framework.

11. The method of claim 10, wherein said framework and said runner are JUnit compliant.

12. A computer readable medium storing instructions, said instructions when executed by a computer system adapting said computer system to:
(a) conduct unit tests on a software application, said unit tests ordered under hierarchical groupings; and
(b) track said unit tests so as to capture a result of each of said unit test and a hierarchical position of each of said unit tests within said hierachical groupings.

13. The computer readable medium of claim 12, wherein said instructions further adapt said computer system to:
(c) output the hierarchical position of each of said unit tests in association with said result.

14. The computer readable medium of claim 13, wherein said instructions further adapt said computer system to:
(d) iteratively conduct at least one of said unit tests multiple times; and
(e) each time one of said unit tests is conducted, associate an iteration ordinal indication with the result obtained.

15. A computer system for testing a software application, comprising:
a central processing unit; and
a memory for storing instructions, which, when executed by said central processing unit, adapt said computer system to:
(a) conduct unit tests on said software application, said unit tests ordered under hierarchical groupings; and
(b) track said unit tests so as to capture a result of each unit test and a hierarchical position of each of said unit tests within said hierarchical groupings

16. The computer system of claim 15, wherein the instructions further adapt said computer system to:
(c) output the hierarchical position of each of said unit tests in association with said result.

17. The computer system of claim 16, wherein the instructions further adapt said computer system to:
(d) iteratively conduct at least one of said unit tests multiple times; and
(e) each time one of said unit tests is conducted, associate an iteration ordinal indication with the result obtained.

18. A system for tracking unit tests of a software application, said system comprising:
(a) means for conducting unit tests on a software application, said unit tests ordered under hierarchical groupings; and
(b) means for tracking said unit tests so as to capture a result of each of said unit tests and a hierarchical position of each of said unit tests within said hierarchical groupings.

19. The system of claim 19, further comprising:
(c) means for outputting the hierarchical position of each of said unit tests in association with the corresponding result.

20. The system of claim 19, wherein at least one of said unit tests is iteratively conducted multiple times, and said system further comprises:
(d) each time said one of said unit tests is conducted, means for associating an iteration ordinal indication with the result obtained.
